(19) United States
(12) Patent Application Publication
(10) Pub. No.: US 2006/0022457 A1
(43) Pub. Date: Feb. 2, 2006

(54) Apparatus for supplying gas to a liquid

(76) Inventor: Arnold Jager, Burgdorf (DE)

Correspondence Address: ROBERT W. BECKER & ASSOCIATES, Suite B, 707 Highway 66 East, Tijeras, NM, 87059, US

(21) Appl. No.: 11/191,612

(22) Filed: Jul. 28, 2005

(30) Foreign Application Priority Data
Jul. 28, 2004 (DE) 10 2004 036 678.0

(51) Int. Cl. F16L 41/00

(52) U.S. Cl. 285/189

(57) ABSTRACT

An apparatus for supplying gas to a liquid, especially for the aeration of water, comprising an aeration element in the form of an elastomeric hose, for example of rubber or rubber-like material, that can receive compressed air. The walls of the hose have perforations fine slits, or other apertures. A portion of the hose extends around a filling member. This portion of the hose, with the filling member, is received in a groove of a retaining member. An opening of the groove is narrower than this portion of the hose.

The instant application should be granted the priority date of Jul. 28, 2004, the filing date of the corresponding German patent application 10 2004 036 678.0.

### BACKGROUND OF THE INVENTION

The present invention relates to an apparatus for supplying gas to liquids, especially for aerating water, and includes an aeration element that can be supplied with compressed air and that comprises an elastomeric hose of rubber or a rubber-like material, with the walls of the hose being provided with a perforation, fine slits, or other apertures, and with the hose being secured to a retaining member, whereby a portion of the hose wall together with a filling body are inserted into a groove.

Such apparatus are primarily used for aerating clarification or settling ponds during the treatment of water.

An apparatus of the aforementioned general type is disclosed in DE 102 20 769 A1, whereby this known apparatus is floatingly disposed in the water, and the hose is directly connected by the groove with a profiled element that serves as reinforcement and as a ballast weight, and is suspended on a float. DE 102 20 769 A1 does not disclose how the hose with the filling body can be introduced into the groove. It is conceivable that the filling body and the double wall thickness of the hose are slightly wider than the opening of the groove. If the filling body and hose are pressed into the groove, the hose, due to its elasticity (rubber or the like) yields and the filling body and the hose snap into the groove. Also conceivable is a clip connection, according to which the walls of the groove are briefly elastically bent to the side. However, in so doing undesirable stresses can be introduced into the hose that during a later operation lead to folds and/or to a poor formation of bubbles, or the hose can even become damaged. If the walls of the groove yield slightly, these problems can be reduced; however, the connection is then also less durable. In addition, there is the danger that during the operation of the apparatus, the filling body and hose can become disengaged from the groove and float upwardly.

Furthermore known from DE 102 03 780 A1 is an apparatus for aerating water that has a hose with a reinforcing bead, whereby the bead can be placed in a groove of a securement element. Although it is indicated that the groove can be separated, there is, however, no description of how this separation should be accomplished.

It is therefore an object of the present invention to improve the connection between the hose and the securement element for apparatus of the aforementioned general type in such a way that the connection is easy to establish, yet is durable and reliable and ensures a reliable operation of the apparatus.

### BRIEF DESCRIPTION OF THE DRAWINGS

This object, and other objects and advantages of the present application, will appear more clearly from the following specification in conjunction with the accompanying schematic drawings, in which:

FIG. 1 is a cross-sectional view of a first embodiment of the inventive apparatus;

FIG. 2 shows a further embodiment of the inventive apparatus with a film-type hinge, and in the opened condition;

FIG. 3 is a cross-sectional view of a further embodiment of the invention, with the groove closed; and

FIG. 4 is a side-view of a portion of the apparatus of FIG. 3.

### SUMMARY OF THE INVENTION

The apparatus of the present application is characterized primarily in that the groove is of such a size that it can accommodate the filling body that is surrounded by the hose, and the opening of the groove is narrower than such filling body.

The groove is advantageously of such a size, and its opening has such a narrowness, that the filling body that is surrounded by a portion of the hose is disposed in the groove in a manner free of stress and yet with play, yet cannot escape through the opening of the groove. Compromises, as are present with a clip connection, are no longer necessary. A further advantage of the invention is that a connection between the hose and the securement or retaining member can be easily released without damaging the individual components, for example in order to undertake repair or maintenance work.

Pursuant to the present application, it makes no difference if the retaining member extends over the entire length of the hose, or if one or more of the retaining members extends over only portions thereof. However, if a plurality of retaining members that are spaced at certain, normally equal, intervals are not adequate, it is recommended pursuant to the present invention that the retaining member extend over the entire length of the hose. To the extent that the groove is sufficiently larger than filling body and hose, the assembly of the apparatus can already be effected during the manufacture. It is then merely necessary to secure the apparatus on, for example, the base of the settling pond.

Pursuant to an advantageous embodiment of the invention, the retaining member is made of an elastic material, and in the region adjoining the groove, opposite the opening of the groove, the material of the retaining member is so thin that it is deformable, thereby forming a film type hinge. By bending the retaining member, the groove can be opened. This embodiment has the advantage that the retaining member can in a simple manner be manufactured as a single piece, for example from a plate or strip of polymeric material.

Pursuant to an alternative embodiment of the invention, the groove is disposed in a component that is comprised of two individual parts, whereby the separating line between the two individual parts extends through the groove and its opening. To open the groove, the individual parts are separated from one another. Both parts can be disposed on a common base, for example on a profiled rail or in a groove, where they can be held in the closed position, for example by screws or appropriate clamping means.

The filling body can have any desired cross-sectional area. In an advantageous embodiment, the filling body is round, either as a rod or as a round tube. However, the filling body can also be oval, right-angled, or quadratic.

In another advantageous embodiment of the invention, the edges or rims of the opening of the groove are rounded off. This prevents the hose from rubbing open on a sharp edge, as a result of which it could become loose from the retaining member or air could leak out.

Further specific features of the present application will be described in detail subsequently.

### DESCRIPTION OF SPECIFIC EMBODIMENTS

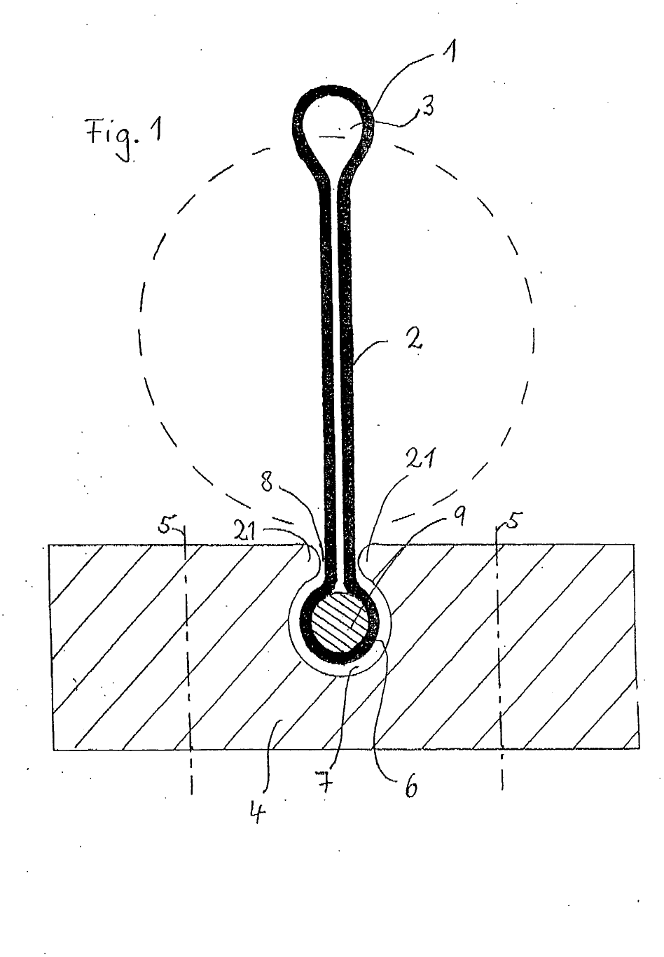

Referring now to the drawings in detail, pursuant to FIG. 1, the apparatus comprises a hose 1, especially a flat hose (see FIG. 4), that is made of elastomeric material such as rubber or a rubber-like material. The hose 1 can be disposed in a tank or other reservoir that contains the liquid to which gas is to be supplied; the hose 1 extends over a great length. The side walls 2 of the hose 1 are perforated, for example by a plurality of fine slits. The upper and lower portions of the wall are free of perforations.

The hose 1 surrounds a hollow space 3, to which air or some other gas can be supplied from one end, while the other end of the hollow space is closed off. If compressed air is supplied to the hose 1, it expands or inflates (as indicated by a dashed lines in FIG. 1), and the air escapes via the fine slits that now open up. If the compressed air supply is terminated, the hose 1 is pressed flat together by the pressure of the surrounding water, whereby the hose is pressed together starting at the bottom and continuing upwardly, since the air escapes in an upward direction.

Where greater lengths of the hose are used, it is advisable to supply air to the hose 1 from both ends of the hollow space 3.

The lower end of the hose 1 is secured to a retaining member 4. The retaining member, in turn, can be secured to the base of the reservoir that is to be aerated, or on supports or the like that are disposed in the reservoir. Screws or dowels serve for the securement, as indicated by the reference numerals 5. To connect the hose 1 with the retaining member 4, a peripheral portion 6 of the hose 1 is inserted into a groove 7 in the retaining member 4. At the top, the groove 7 has an opening 8 that is distinctly narrower than is the groove 7 itself. Within the groove 7, the hose portion 6 forms a loop that extends around a filling body 9 that is inserted through the loop. The filling body 9 is a rod, and can be made of metal, although it is preferably made of polymeric material, especially glass fiber reinforced polymeric material. The filling body 9 prevents the portion 6 of the hose 1 from being pulled out of the groove 7 since its diameter is greater than the opening 8 of the groove 7.

The edges or rims 21 of the opening of the groove 7 are preferably rounded off. This prevents the hose 1 from being rubbed open and leaking in this area during operation.

The retaining member 4 comprises a plate or strip of polymeric material. The groove 7 extends through the entire length of the plate.

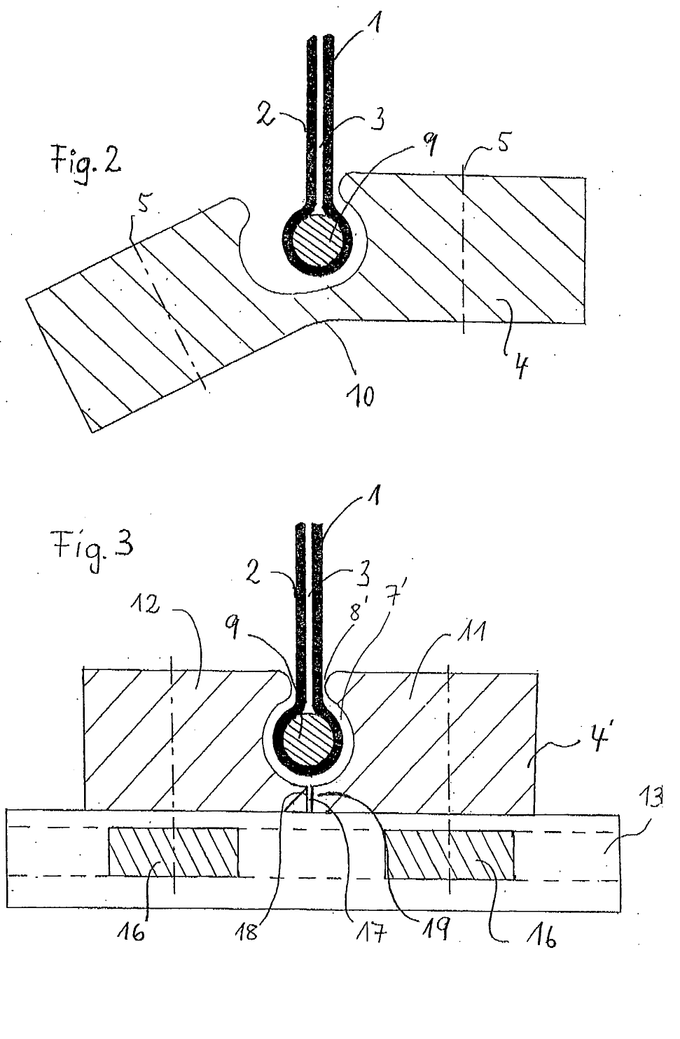

FIG. 2 shows an embodiment in which the plate is very thin in the region of the groove 7. As a result, a film type hinge 10 is formed at this location. Due to the presence of the film type hinge 10, the retaining member 4 can be bent. As a consequence, the groove 7 is opened. The opening 8 of the groove 7 is thereby widened to such an extent that the hose 1, together with the filling body 9 that is disposed in the portion 6 thereof, can be easily inserted into the groove 7. This prevents the walls of the groove 7 from exerting pressure upon the hose 1. When the retaining member 4 is again straightened out, the groove 7 is closed and the filling body 9 is restrained in the groove 7. By means of the aforementioned assembly via the screws 5, the retaining member 4 is held in a straight position, and hence the hose 1 is held in the groove 7.

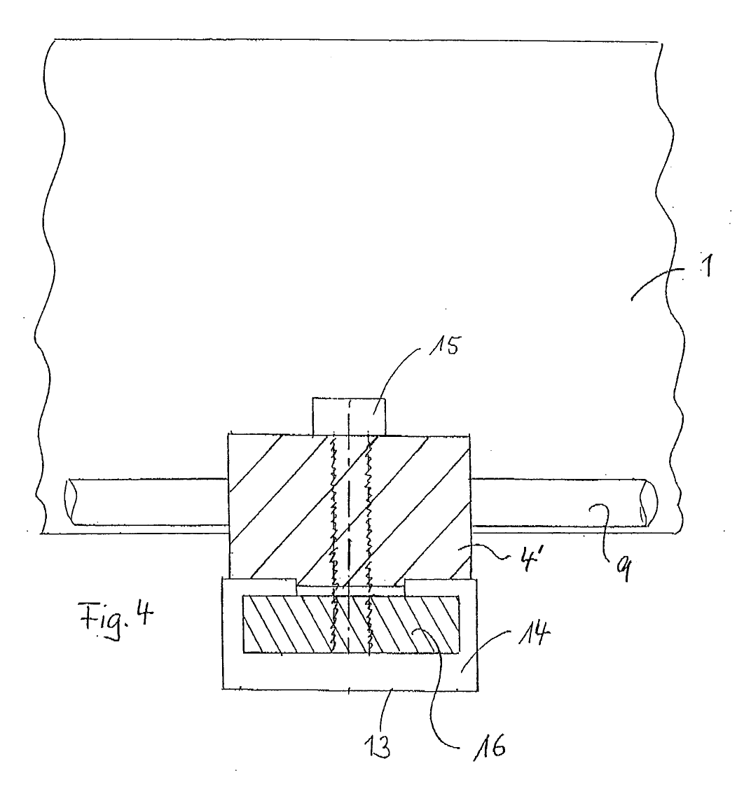

With the modified embodiment of the present application pursuant to FIGS. 3 and 4, the retaining member 4′ has two parts 11 and 12 that together are disposed on a guide rail 13. The rail 13 has a partially closed U-shaped profiled member 14. The parts 11 and 12 of the retaining member 4′ can be secured at any position on the guide rail 13 by screws 15 that extend through the retaining member, and that are guided in the U-shaped profiled member 14 via hammer heads 16.

The facing sides of the parts 11 and 12, when they abut one another, form a groove 7′ that is comparable to the groove described in connection with the embodiment of FIG. 1 and which is suitable for accommodating the filling body 9 that is surrounded by a hose portion 6. The separating line 17 between the parts 11 and 12 extends through the groove 7′ and its opening 8′. The parts 11 and 12 contact one another merely via projecting portions 18 and 19 that are disposed below the groove 7′.

To open the groove 7′, the screws 15 are loosened and the parts 11 and 12 are moved away from one another. The hose 1, together with the filling body 9, can then be introduced. Subsequently, the parts 11 and 12 are again shoved together until their projecting portions 18 and 19 abut against one another; the screws 15 are then tightened. The opening 8′ of the groove 7′ is then narrowed to such an extent that the hose 1 with the filling body 9 is restrained in the groove 7′.

The specification incorporates by reference the disclosure of German priority document 10 2004 036 678.0 filed Jul. 28, 2004.

The present invention is, of course, in no way restricted to the specific disclosure of the specification and drawings, but also encompasses any modifications within the scope of the appended claims.

What I claim is:

1. An apparatus for supplying gas to a liquid, comprising:
an aeration element in the form of an elastomeric hose that is adapted to receive pressurized gas, wherein said hose is provided with walls that are partially provided with perforations, fine slits, or other apertures;
a filling member about which a portion of said hose extends; and
a retaining member having a groove for receiving said portion of said hose together with said filling member, wherein an opening of said groove is narrower than said portion of said hose that extends about said filling member.

2. An apparatus according to claim 1, wherein said retaining member is movable, and wherein via a movement of said retaining member said opening of said groove is adapted to be enlarged to such an extent that said opening is wider than said filling member and said portion of said hose that extends about it.

3. An apparatus according to claim 1, wherein said retaining member is provided with a hinge below said groove remote from said opening of said groove.

4. An apparatus according to claim 3, wherein said hinge is a film type hinge.

5. An apparatus according to claim 1, wherein said groove is disposed in a retaining member that is comprised of two individual parts that are separated from one another by a separating line that extends through said groove and said opening thereof.

6. An apparatus according to claim 5, wherein a guide rail is provided, and wherein said two individual parts are disposed on said guide rail in such a way that they are displaceable and fixable in position on said rail.

7. An apparatus according to claim 1, wherein edges of said opening of said groove are rounded off.
